(19) United States
(12) Patent Application Publication
(10) Pub. No.: US 2004/0246234 A1
(43) Pub. Date: Dec. 9, 2004

(54) Display apparatus

(76) Inventors: Luis Serra, Balmoral Park (SG); Ralf Alfons Kockro, Eucalia Block (SG); Hern Ng, Sengkang East (SG)

Correspondence Address: KRAMER LEVIN NAFTALIS & FRANKEL LLP, INTELLECTUAL PROPERTY DEPARTMENT, 919 THIRD AVENUE, NEW YORK, NY, 10022, US

(21) Appl. No.: 10/469,294

(22) PCT Filed: Mar. 1, 2001
(86) PCT No.: PCT/SG01/00048

(51) Int. Cl. G09G 5/00

(52) U.S. Cl. 345/168

(57) ABSTRACT

A virtual reality display apparatus is disclosed which includes a display (100) arranged to display an image (130) viewable in three dimensions in an image space and, spaced from the image space, a three-dimensional work space (240), operation of a tool (230) within the work space being viewable in the image space.

### BACKGROUND AND FIELD OF THE INVENTION

This invention relates to a display apparatus for viewing and operating upon three dimensionally-viewable images.

A three-dimensional display apparatus has been proposed in (1) “Interaction Techniques for a Virtual Work space” (Serra, Poston, Ng and Chua) Proceedings ICAT/NRST-95-ACM Virtual Reality Software and Technology 1995, Chiba, Japan and in (2) “An Interface for Precise and Comfortable 3D work with Volumetric Medical Datasets” (Serra, Ng, Chua, Lee, Lee, Yeo, Chan and Kockro). Proceedings of the conference “Medicine Meets Virtual Reality: 7” Jan. 20-23 1999—San Francisco, USA, as well as other related papers and literature.

This apparatus is shown in FIG. 1 and allows a user 8 to operate on a three dimensional image 10 in a virtual work space 12. The apparatus comprises a display screen 14 and a mirror 16 which reflects an image on the screen 14 towards the user 8. The screen 14 displays stereoscopic images 10 and the user wears stereoscopic glasses 20 to enable a three-dimensional image 10 to be seen. Due to the relative positioning of the screen 14 and mirror 18, the image 10 appears to be below the mirror in the virtual work space 12. A stylus 24 having a three-dimensional tracking device may be manipulated by the user 8 within the work space 12 to perform operations on the image 10. A virtual image of a tool that the stylus 24 represents is displayed on the screen and operations performed by the tool are fed back through a digital processor to change the image on the display screen 14 in real time.

It is a disadvantage of this display apparatus that is due to the relative disposition of display, mirror and work space, it is only possible for the user and one or two others to observe the operations being performed.

The apparatus disclosed in Paper (2) noted above further proposes the use of a virtual control panel at a surface at the edge of the work space. Movement of a tool within the work space allows the tool to operate upon the virtual image within the image space. Movement to the surface outside the work space allows the user to interact with a two-dimensional virtual control panel displayed on the screen 14, to change the nature of the tool revealed by the stylus 24 for example.

While access to the two-dimensional control panel provides flexibility in tool selection and change of parameters, this is essentially limited by requiring interaction with a single stylus. The speed with which the control panel may be used is, therefore, limited.

It is an object of the invention to alleviate at least one of the aforementioned disadvantages of the prior art.

### SUMMARY OF THE INVENTION

According to the invention in the first aspect there is provided a display apparatus comprising a display arranged to display an image viewable in three dimensions in an image space and, spaced from the image space, a three-dimensional work space, operation of the tool within the work space being viewable in the image space.

In the described embodiment, a screen-based stereoscopic display is provided which can be viewed by an audience. A separate stand for a user is provided which includes at least one tool, the position of which can be three-dimensionally sensed. The work space is defined adjacent the stand so that the tool may be used within the space.

Preferably, the space is bounded on one side by a surface and when the tool touches the surface, this activates a two-dimensional menu which can interact with the user.

Operation of the tool within the work space and on the surface are viewable in the image space so that they can be viewed by the audience.

According to the invention in the second aspect there is provided a virtual reality display apparatus comprising a display arranged to display an image viewable in three dimensions in an image space and a three-dimensional work space, operation of a tool within the work space being viewable in the image space and further comprising a keyboard and a member having a surface adjacent a boundary of the work space, the member being movable to provide access to the keyboard.

In the described embodiment, the surface is provided on one side of a rotable member with the keyboard being provided on the other side of the member so that when the member is rotated, the keyboard is accessible to the user, to allow the user to use the keyboard in conjunction with the image. Since the keyboard is a multi-digit input device, this allows faster input, for example, of text annotations to the image, than would be possible with a stylus-operated menu.

### BRIEF DESCRIPTION OF THE DRAWINGS

Embodiments of the invention will now be described, by way of example, with reference to the accompanying drawings in which:

FIG. 1 is a schematic view of a prior art display apparatus;

FIG. 2 is a schematic diagram of the first embodiment of the invention;

FIG. 3 is a three-dimensional view of user apparatus of the embodiment of FIG. 2;

FIG. 4 is a view of the display of the embodiment of FIGS. 2 and 3;

FIG. 5 is a more detailed view of the work space of the user apparatus of the embodiments of FIGS. 2-4;

FIGS. 6 and 7 illustrate a second embodiment of the invention.

### DETAILED DESCRIPTION OF THE PREFERRED EMBODIMENT

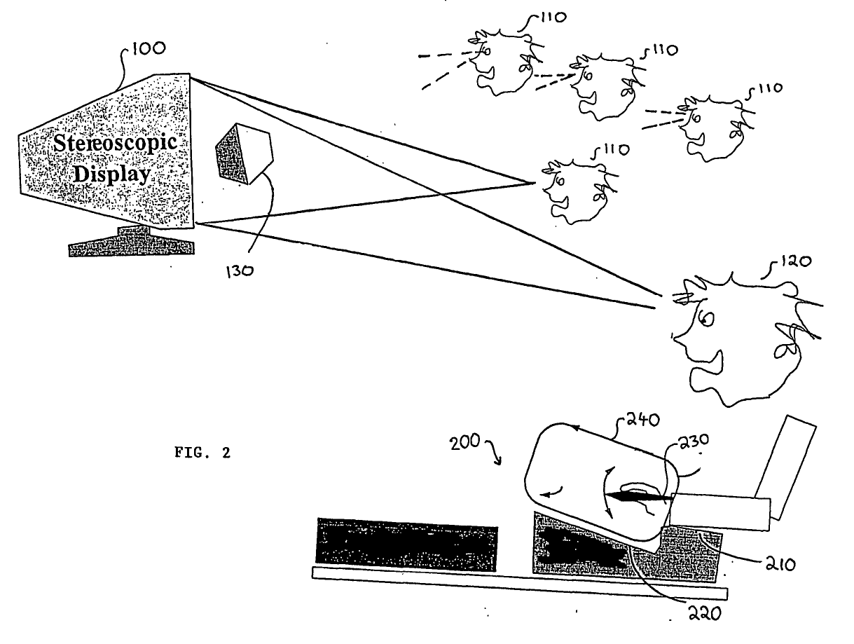

The first embodiment of the invention is illustrated in FIGS. 2-5 and comprises a stereoscopic display 100 which may be in a form of a visual display unit but is preferably in the form of the screen on which stereoscopic images are projected by a projector. The display 100 may be viewed by an audience 110 and a user/operator 120. As the display is stereoscopic, two images would be provided, which are viewed via the stereoscopic glasses and converged in the brain to form a single three-dimensional image. The audience and operator are each provided with stereoscopic glasses (not shown) to view the display 100 so that an image shown on or projected by the display 100 is viewable as a three-dimensional image 130 within a surrounding image space.

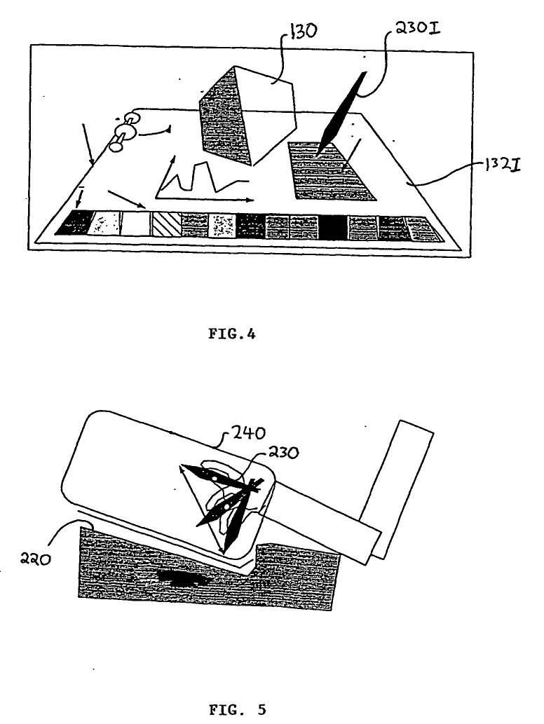

The user/operator 120 is provided with a user apparatus 200. The apparatus 200 is preferably free standing and provides a support 210 for an arm of the user and a work surface 220. A tool 230 is able to be grasped by the user so as to be movable within a work space 240. The tool 230 has three dimensional positioning means which is sensed by at least one sensor (not shown) so that its position may be determined. The work space 240 is arranged to be adjacent to a surface 220 so that if the tool 230 touches surface 220, this enables a two dimensional menu 132I to be displayed by the display 100 in addition to or instead of the object image 130. The display will show an image of the tool 230I depending on the tool chosen. The composite image displayed by the display 100 is illustrated in FIG. 4.

The digital processing techniques for generation of the image 130 and for operation of the tool 230 on the image 130 are the same as disclosed in the prior literature noted above. In the prior art, the work space and the image space are in registration. However, in the embodiment of the present invention, the image space and work space are spaced one from the other, the position of the tool 230 being calibrated in a set-up phase by registering the position of the tool 230 at the location and maximum extent of the work space and location and dimension of the surface 220 so that the image of the position and movement of the tool 230 in the work space 240 occurs in the image space to be viewable by the operator and audience. As a result of the spacing of the image and work space, the operator 120 need not be within arm reach of the perceived image 130. This allows the audience 110 to have uninterrupted sight of the image space and any operations performed the image 130, by the operator 120.

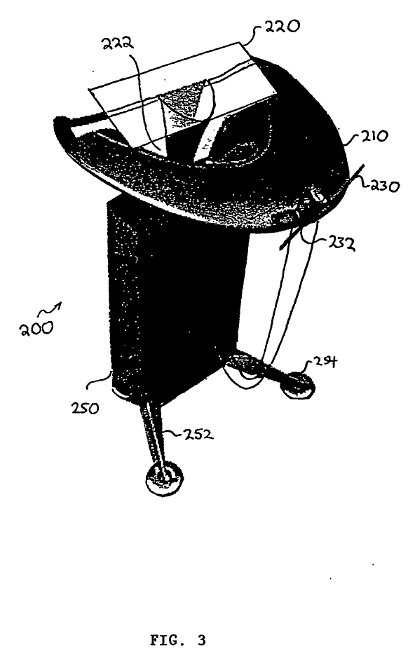

The apparatus 200 is shown in more detail in FIG. 3 and is essentially in the form of a self-standing lectern including a support member 250 connected to protruding support legs 252, 254. The arm support 210 is connected to the support member 250 and is set at a slanted angle to the horizontal. A tool 230 (and optionally a second tool 232) are connected by means of wires to the base 250 and, from there, to a digital processing device (not shown) which is in turn connected to and drives the stereoscopic display 100. A sheet of translucent glass provides the surface 220. An opening 222 is provided between the glass and the arm support 210.

The work space 240 is shown in more detail in FIG. 5 and is essentially three-dimensional (two dimensions being shown in FIG. 5). When the tool 230 is disposed within the work space 240, the selected virtual tool can operate upon the image 130. When the tool 230 exists from the work space 240 in the direction of surface 220, this is sensed by the three-dimensional sensors attached to the tool 230 which will cause display of the menu 1321 on display 100. The tool 230 can then be used to select items on the menu.

When in use, the display will show the image 130 together, optionally, with a virtual control panel 132. The control panel may include many options and tools for use in operating upon the image 130 in different ways.

Although the first embodiment has been described using a stereoscopic display, any other form of display which displays an image that appears three dimensional may be used, for example one which uses holographic techniques or displays an image in perspective.

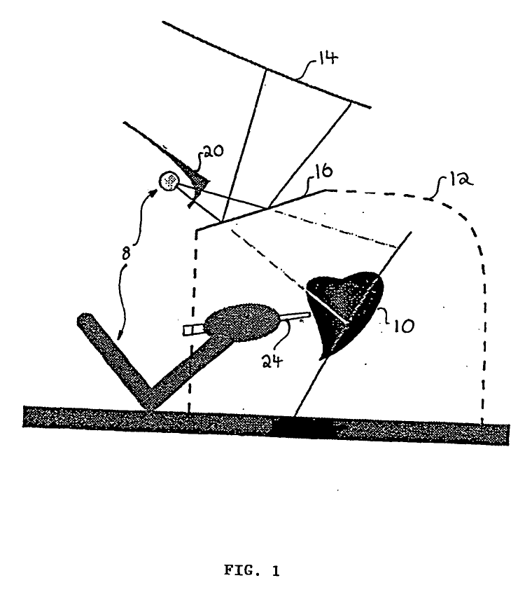

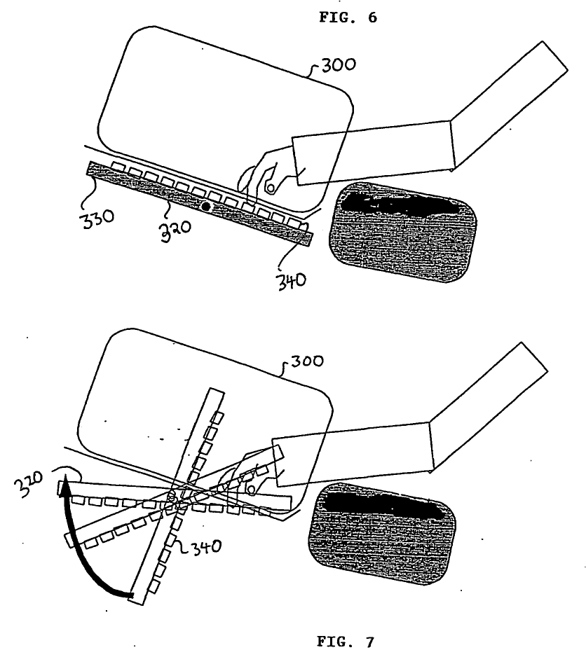

With reference to FIGS. 6 and 7, a second embodiment of the invention is shown. In this embodiment, the work space is designated 300 and this can be in registration with the image space, in the manner of the prior art in FIG. 1, or spaced from the image space in the manner of the embodiment of FIG. 2. A surface 320 is provided on one side of a rotatable support member 330. On the reverse of the member 330, a keyboard 340 is provided. In use, the surface 220 can be used to access a menu in a manner described with reference to the embodiment of FIG. 2. However, if it is desired, for example to annotate or attach text to the display, member 330 can be rotated to present the keyboard for use by the user.

1. A display apparatus comprising a display arranged to display an image viewable in three dimensions in an image space and, spaced form the image space, a three-dimensional work space, wherein operation of a tool within the work space is viewable in the image space.

2. The apparatus of claim 1, further comprising a user apparatus including a said tool, the work space being defined adjacent to the user apparatus.

3. The apparatus of claim 2 wherein the user apparatus includes a two-dimensional surface adjacent to a side of the work space.

4. The apparatus of claim 2, further comprising a keyboard.

5. The apparatus of claim 2 wherein the surface is provided on one side of a rotatable member, the keyboard being provided on a reverse side of the member.

6. The apparatus of claim 2 wherein the user apparatus is free standing.

7. The apparatus of claim 2 wherein the user apparatus includes an arm support.

8. The apparatus of claim 1 wherein the display includes a screen and a projection means.

9. The apparatus of claim 1 wherein the display is a visual display unit.

10. A display apparatus comprising:
a display arranged to display
an image viewable in three dimensions in an image space and a three-dimensional work space, operation of a tool within the work space being viewable in the image space;
a member provided with a surface adjacent a boundary of the work space; and
a keyboard, the member being movable to provide access to the keyboard.

11. The apparatus of claim 10 wherein the image space is spaced from the work space.

12. The apparatus of claim 10 wherein the image space and work space are in registration.

13. The apparatus of claim 10 wherein the member is rotatable and the keyboard is provided on a reverse side of the member to the surface.
